(19) United States
(12) Patent Application Publication
(10) Pub. No.: US 2020/0119671 A1
(43) Pub. Date: Apr. 16, 2020

(54) STEPLESS SPEED CONTROL CIRCUIT OF ELECTRIC SPRAYER

(71) Applicant: SUZHOU CROSSTEC CO., LTD., Suzhou (CN)

(72) Inventor: Xiaobing ZHANG, Suzhou (CN)

(21) Appl. No.: 16/421,438

(22) Filed: May 23, 2019

(30) Foreign Application Priority Data
Oct. 11, 2018 (CN) 201811181160.5
Oct. 11, 2018 (CN) 201821644828.0

(51) Int. Cl. H02P 7/288; B05B 12/00

(52) U.S. Cl. CPC H02P 7/288; B05B 12/00

(57) ABSTRACT

The present discloses a stepless speed control circuit of an electric sprayer, wherein the stepless speed control circuit comprises a stepless speed control switch, an LDO, an MCU and an MOS tube; the stepless speed control switch, adjusting working voltage of the electric motor through a sliding resistor, has its two terminals respectively connected to the positive pole of the electric motor and an input of the LDO, with the working voltage supplied to the MCU via an output of the LDO; the sliding resistor of the stepless speed control switch, also connected to the MCU, collects the voltage of the electric motor and sends it to the MCU; with the MOS tube connected in series to a negative power supply line of the battery pack, the MCU connects the MOS tube and controls the duty ratio thereof.

This application claims the priority benefit of Chinese Patent Application Nos. 201811181160.5 and 201821644828.0, both filed on Oct. 11, 2018 and entitled “stepless speed control circuit of electric sprayer,” both of which are incorporated by reference in their entirety.

### TECHNICAL FIELD

The present invention relates to the field of pet care products, and in particular to a pet care tool.

### BACKGROUND

The speed of electric sprayers currently available on the market is generally adjusted by the gear position, such that the spray amount cannot be adjusted more freely. When the constant voltage value of the motor is low, the water spray head is closed, the motor is blocked, and the rotational speed is insufficient to get the pressure switch cut off, which may make the motor burnt.

### SUMMARY

The object of the present invention is to provide a stepless speed control circuit of an electric sprayer, so as to achieve stepless regulation of the electric sprayer and auxiliary protection against motor blockage.

The present invention adopts the following technical solution:

A stepless speed control circuit of an electric sprayer is provided, wherein the electric motor of the electric sprayer is powered by connection of positive and negative poles of a battery pack, and the stepless speed control circuit comprises a stepless speed control switch, an LDO, an MCU and an MOS tube; the stepless speed control switch, adjusting the working voltage of the electric motor through a sliding resistor, has its two terminals respectively connected to the positive pole of the electric motor and an input of the LDO, with working voltage supplied to the MCU via an output of the LDO; the sliding resistor of the stepless speed control switch, also connected to the MCU, collects the voltage of the electric motor and sends it to the MCU; with the MOS tube connected in series to a negative power supply line of the battery pack, the MCU connects the MOS tube and controls the duty ratio thereof.

Preferably, a sampling resistor for collecting current, connected to the MCU through an operational amplifier, is also connected in series to the negative power supply line of the battery pack.

Preferably, a pressure switch, also connected in series to a positive power supply line of the electric motor, is controlled to get cut off by water sprayed by the electric sprayer.

Preferably, the stepless speed control switch changes the output voltage of the battery pack by adjusting the resistance of the sliding resistor, thereby controlling and adjusting the rotational speed of the electric motor.

Preferably, when the stepless speed control switch is closed, the positive pole of the battery pack supplies power to the MCU through the LDO, and the MCU adjusts the duty ratio by controlling the switching duty ratio of the MOS tube and detecting a voltage value of the motor in real time, so as to achieve a constant motor voltage with feedback.

Preferably, when the constant voltage value of the electric motor is low, the water spray head is closed, the motor is blocked, and the rotational speed is insufficient to get the pressure switch cut off, such that the motor may be burnt; the operating current of the electric motor is collected by the sampling resistor to determine whether the electric motor is blocked; if the electric motor is blocked, the switching duty ratio of the MOS is adjusted larger, so that the pressure switch is cut off.

Preferably, a threshold for determining the blockage current of the electric motor is set respectively according to the voltage range of the battery pack and the constant voltage range of the electric motor; when the operating current of the electric motor is greater than the threshold, the electric motor is determined to have been blocked.

The present invention has the following advantages:

In the stepless speed control circuit of the electric sprayer provided by the present invention, the MCU adjusts the duty ratio by controlling the switching duty ratio of the MOS tube and detecting the limited voltage value across the two ends of the motor in real time, so as to achieve a constant motor voltage with feedback, which enables stepless regulation of the electric sprayer. The operating current of the motor is used to determine whether the motor is blocked; if the motor is blocked, the switching duty ratio of the MOS is adjusted larger, so that the pressure switch is cut off, thus achieving auxiliary protection against motor blockage.

### BRIEF DESCRIPTION OF DRAWINGS

The present invention will be further described below with reference to drawings and examples.

FIG. 1 shows the principle of the stepless speed control circuit of the electric sprayer of the present invention.

### DETAILED DESCRIPTION OF PREFERRED EMBODIMENTS

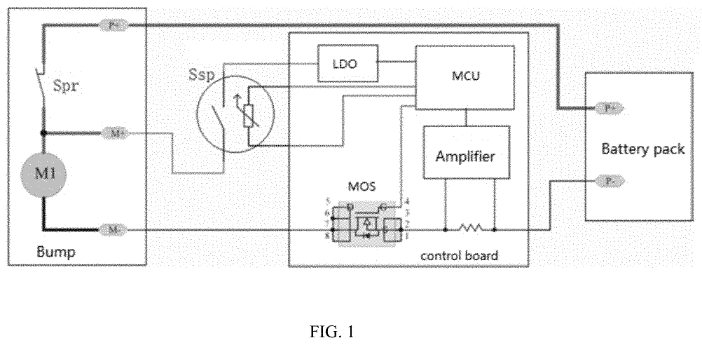

The principle of the stepless speed control circuit of the electric sprayer of the present invention is as shown in FIG. 1. The electric motor M1 of the electric sprayer is powered by connection of positive and negative poles of a battery pack. The stepless speed control circuit comprises a stepless speed control switch Ssp, and a control board composed of an LDO, an MCU, an MOS tube, an operational amplifier and a sampling resistor RES.

The stepless speed control switch Ssp, adjusting working voltage of the electric motor through a sliding resistor, has its two terminals respectively connected to the positive pole of the electric motor and an input of the LDO, with the working voltage of 3.3-5 V supplied to the MCU via an output of the LDO. The sliding resistor of the stepless speed control switch, also connected to the MCU, collects the voltage of the electric motor and sends it to the MCU. The MOS tube is connected in series to a negative power supply line of the battery pack.

When the stepless speed control switch is closed, the positive pole of the battery pack supplies power to the MCU through the LDO, bringing the control board into a working state. The stepless speed control switch changes the output voltage of the battery pack by adjusting the resistance of the sliding resistor, thereby controlling and regulating the rotational speed of the electric motor. The resistance of the sliding resistor of the stepless speed control switch is 40 K to 90 K, corresponding to the constant voltage value of 6.5 V to the voltage of the current battery pack. The sliding resistor collects the voltage of the electric motor, and sends it to the MCU. The MCU adjusts the duty ratio by controlling the switching duty ratio of the MOS tube and detecting a voltage value of the motor in real time, so as to achieve a constant motor voltage with feedback.

A sampling resistor RES for collecting current, connected to the MCU through an operational amplifier, is also connected in series to the negative power supply line of the battery pack. A pressure switch Spr, also connected in series to a positive power supply line of the electric motor, is controlled to get cut off by water sprayed by the electric sprayer.

When the constant voltage value of the electric motor is low, the water spray head is closed, the motor is blocked, and the rotational speed is insufficient to get the pressure switch cut off, such that the motor may be burnt. Therefore, a current value of the running electric motor is collected via the sampling resistor for determining whether the electric motor is blocked; if the electric motor is blocked, the duty ratio of the MOS switch is adjusted larger, so that the pressure switch is cut off.

Because the blockage current of the motor is related to the voltage of the battery pack and the constant voltage value of the motor, a threshold for determining the blockage current of the electric motor is set respectively according to the voltage range of the battery pack and the constant voltage range of the electric motor; when the operating current of the electric motor is greater than the threshold, the electric motor is determined to have been blocked. Table 1 shows the threshold of the blockage current.

TABLE 1
Threshold of blockage current

| | Constant motor | | |
|---|---|---|---|
| | voltage (V) | | |
| Battery pack voltage (V) | 6~8 | 8~10 | 10~12 |
| 13.75~16 | 2 A | 2.5 A | 3.5 A |
| 16~21 | 1.5 A | 2.5 A | 3 A |

Since the pressure switch can be normally cut off when the constant voltage value of the motor is 12 V or more, the auxiliary protection against blockage is not required.

The above examples are only intended to illustrate the technical concept and the features of the present invention, so as to enable those skilled in the art to understand the present invention and implement it. The scope of protection of the present invention is not limited by the above examples. Any modification made according to the spiritual substance of the main technical solution of the present invention will all fall within the scope of protection of the present invention.

What is claimed is:

1. A stepless speed control circuit of an electric sprayer, wherein an electric motor of the electric sprayer is powered by connection of positive and negative poles of a battery pack, characterized in that: the stepless speed control circuit comprises a stepless speed control switch, an LDO, an MCU and an MOS tube; the stepless speed control switch, adjusting working voltage of the electric motor through a sliding resistor, has its two terminals respectively connected to the positive pole of the electric motor and an input of the LDO, with the working voltage supplied to the MCU via an output of the LDO; the sliding resistor of the stepless speed control switch, also connected to the MCU, collects the voltage of the electric motor and sends it to the MCU; with the MOS tube connected in series to a negative power supply line of the battery pack, the MCU connects the MOS tube and controls the duty ratio thereof.

2. The stepless speed control circuit of the electric sprayer according to claim 1, characterized in that: a sampling resistor for collecting current, connected to the MCU through an operational amplifier, is also connected in series to the negative power supply line of the battery pack.

3. The stepless speed control circuit of the electric sprayer according to claim 2, characterized in that: a pressure switch, also connected in series to a positive power supply line of the electric motor, is controlled to get cut off by water sprayed by the electric sprayer.

4. The stepless speed control circuit of the electric sprayer according to claim 1, characterized in that: the stepless speed control switch changes the output voltage of the battery pack by adjusting the resistance of the sliding resistor, thereby controlling and adjusting the rotational speed of the electric motor.

5. The stepless speed control circuit of the electric sprayer according to claim 4, characterized in that: when the stepless speed control switch is closed, the positive pole of the battery pack supplies power to the MCU through the LDO, and the MCU adjusts the duty ratio by controlling the switching duty ratio of the MOS tube and detecting a voltage value of the motor in real time, so as to achieve a constant motor voltage with feedback.

6. The stepless speed control circuit of the electric sprayer according to claim 3, characterized in that: when the constant voltage value of the electric motor is low, the water spray head is closed, the motor is blocked, and the rotational speed is insufficient to get the pressure switch cut off, such that the motor may be burnt; the operating current of the electric motor is collected by the sampling resistor to determine whether the electric motor is blocked;
if the electric motor is blocked, the switching duty ratio of the MOS is adjusted larger, so that the pressure switch is cut off.

7. The stepless speed control circuit of the electric sprayer according to claim 6, characterized in that: a threshold for determining the blockage current of the electric motor is set respectively according to the voltage range of the battery pack and the constant voltage range of the electric motor; when the operating current of the electric motor is greater than the threshold, the electric motor is determined to have been blocked.
